(19) United States
(12) Patent Application Publication
(10) Pub. No.: US 2010/0118440 A1
(43) Pub. Date: May 13, 2010

(54) CAGE

(75) Inventors: Fan-Lan Qu, Shanghai City (CN); Shi-Feng Wang, Shanghai City (CN); Tsai-Kuei Cheng, Taipei City (TW)

Correspondence Address: J C PATENTS, 4 VENTURE, SUITE 250, IRVINE, CA, 92618, US

(73) Assignee: INVENTEC CORPORATION, Taipei City (TW)

(21) Appl. No.: 12/345,433

(22) Filed: Dec. 29, 2008

(30) Foreign Application Priority Data
Nov. 11, 2008 (CN) 200810174896.X

(51) Int. Cl. G11B 23/03; G06F 1/16

(52) U.S. Cl. 360/133; 361/679.31; G9B/23.02; G9B/23.023

(57) ABSTRACT

A cage adapted to carry a plurality of disc drives and fix the disc drives within a case of a computer host is provided. The computer host has a mother board. The disc drives are spread horizontally within the cage, so that the disc drives are hung above the mother board.

### CROSS-REFERENCE TO RELATED APPLICATION

This application claims the priority benefit of P.R.C. patent application serial no. 200810174896.X, filed on Nov. 11, 2008. The entirety of the above-mentioned patent application is hereby incorporated by reference herein and made a part of specification.

### BACKGROUND OF THE INVENTION

1. Field of the Invention

The present invention generally relates to a cage and a computer host using the cage, in particular, to a cage that can hold a plurality of disc drives simultaneously and a computer host using the cage.

2. Description of Related Art

Nowadays, as computer peripherals become increasingly prevailing, a computer host with a sufficient large expansion space or a thin computer fitting has become inevitable trends. A computer host is generally reserved with a plurality of accommodation spaces therein for carrying disc drives, so as to be embedded with hard disc drives, optical disc drives, recorders, and other disc drives respectively. However, the volume of the computer host trends to be reduced. Specifically, besides the cases with an ATX specification available in the market, other cages for Barebones or Micro-ATX cases with a smaller size have gradually appeared in the market. However, an inner space of such computer hosts with a smaller size is more limited, and thus, how to make full use of the inner space of the computer host for achieving a maximum performance becomes an important issue.

FIG. 1 is a schematic view of a conventional computer host combined with disc drives, and FIG. 2 is a schematic view of the combination shown in FIG. 1 as seen from another viewing angle. Referring to FIGS. 1 and 2, a computer host 100 has a case 101, an expansion shelf 102 for accommodating an optical disc drive 110, a hard disk shelf 103 for accommodating a hard disc drive 120, and a mother board 104. The expansion shelf 102 is disposed close to a front surface of the case 101, and the hard disk shelf 103 is disposed adjacent to a bottom of the expansion shelf 102.

In the prior art, the expansion shelf 102 and the hard disk shelf 103 are stacked together and disposed within the computer host 100. Thus, if an overall height of the computer host 100 is reduced or restricted, a distance between the hard disk shelf 103 and the mother board 104 disposed on the bottom of the case 101 is reduced or restricted, and as a result, a height of a heat sink (not shown) disposed on the mother board 104 is also restricted. In this way, the heat dissipation efficiency of the heat sink may be definitely influenced.

FIG. 3 is a schematic view of another conventional computer host combined with disc drives. Referring to FIG. 3, a computer host 200 has a case 201, two boxes 202 and 203, a fixing shelf 204, and a mother board 205 disposed on a bottom of the case 201. Disc drives 210 and 220 are respectively accommodated within the boxes 202 and 203, and fixed at the top of the case 20 by the fixing shelf 204 for carrying the boxes 202 and 203. Therefore, in the prior art, the number of the boxes 202 and 203 should correspond to that of the disc drives 210 and 220. In other words, if a plurality of disc drives needs to be accommodated therein, an equivalent number of boxes should be configured within the fixing shelf 204. As a result, there are still some inconveniences in usage.

Besides, in the prior art, the fixing shelf 204 and the boxes 202 and 203 can only be used to accommodate storage devices without operation panels such as hard disc drives. Therefore, storage devices with operation panels, such as optical disc drives, must be disposed beneath the fixing shelf 204. In this manner, if the overall height of the computer host 200 is reduced, a height of a heat sink (not shown) disposed on the mother board 205 is restricted, thereby influencing the heat dissipation efficiency of the heat sink.

### SUMMARY OF THE INVENTION

Accordingly, the present invention is directed to a cage adapted to hang a plurality of disc drives within a case in a horizontal spreading manner.

The present invention is further directed to a computer host, in which a plurality of disc drives is hung within a case a horizontal spreading manner by using a cage, so that an inner space of the computer host is utilized efficiently.

As embodied and broadly described herein, the present invention provides a cage, adapted to carry a plurality of disc drives and fix the disc drives within a case of a computer host. The computer host has a mother board, and the disc drives are spread horizontally within the cage, so that the disc drives are hung above the mother board.

In an embodiment of the present invention, the cage includes a frame and pairs of plate parts. The plate parts are connected to the frame and extend towards one side of the frame, so as to define a plurality of disc drive assembly slots at one side of the frame. In addition, each of the disc drives is fixed in one disc drive assembly slot defined by one pair of plate parts, so that the disc drives are spread horizontally on the frame.

In an embodiment of the present invention, the frame has at least one protruding structure protruding towards the other side of the frame.

In an embodiment of the present invention, the protruding structure includes a circular protruding structure or a strip-shaped protruding structure.

In an embodiment of the present invention, the frame has at least one assembly hole.

In an embodiment of the present invention, a part of the plate parts is integrated with the frame, and the remaining plate parts are assembled on the frame.

In an embodiment of the present invention, a size of a part of the plate parts corresponds to a thickness of a hard disc drive, and a size of another part of the plate parts corresponds to a thickness of an optical disc drive.

In an embodiment of the present invention, the cage further includes a plurality of stand-offs for assembly disposed on a part of the plate parts and the stand-offs extend outwards.

The present invention further provides a computer host using such a cage, which includes a case, a mother board, a plurality of disc drives, and a cage for carrying the disc drives. The mother board, the disc drives, and the cage are all disposed within the case. The cage carries the disc drives, and the disc drives are spread horizontally within the cage, so that the disc drives are hung above the mother board.

In an embodiment of the present invention, the cage includes a frame and pairs of plate parts. The plate parts are connected to the frame and extend towards one side of the frame, so as to define a plurality of disc drive assembly slots at one side of the frame. Furthermore, each of the disc drives is fixed in one disc drive assembly slot defined by one pair of plate parts, so that the disc drives are spread horizontally on the frame.

In an embodiment of the present invention, the case includes a Micro-ATX case.

In an embodiment of the present invention, the frame is substantially in parallel with the mother board.

In an embodiment of the present invention, the case has a plurality of openings, so that the disc drives carried by the cage are exposed out of the case.

In an embodiment of the present invention, the frame has at least one protruding structure that protrudes towards the other side of the frame.

In an embodiment of the present invention, the protruding structure includes a circular protruding structure or a strip-shaped protruding structure.

In an embodiment of the present invention, the frame has at least one assembly hole.

In an embodiment of the present invention, a part of the plate parts is integrated with the frame, and the remaining plate parts are assembled on the frame.

In an embodiment of the present invention, a size of a part of the plate parts corresponds to a thickness of a hard disc drive, and a size of another part of the plate parts corresponds to a thickness of an optical disc drive.

In an embodiment of the present invention, the computer host further includes a plurality of stand-offs for assembly disposed on the cage and a plurality of assembly holes located on the case, and through the stand-offs for assembly and the assembly holes, the cage is hung within the case.

In the present invention, through using the cage, a plurality of disc drives is hung at one side of the case in a horizontal spreading manner, so as to make full use of the inner space of the computer host.

### BRIEF DESCRIPTION OF THE DRAWINGS

The accompanying drawings are included to provide a further understanding of the invention, and are incorporated in and constitute a portion of this specification. The drawings illustrate embodiments of the invention and, together with the description, serve to explain the principles of the invention.

FIG. 1 is a schematic view of a conventional computer host combined with disc drives.

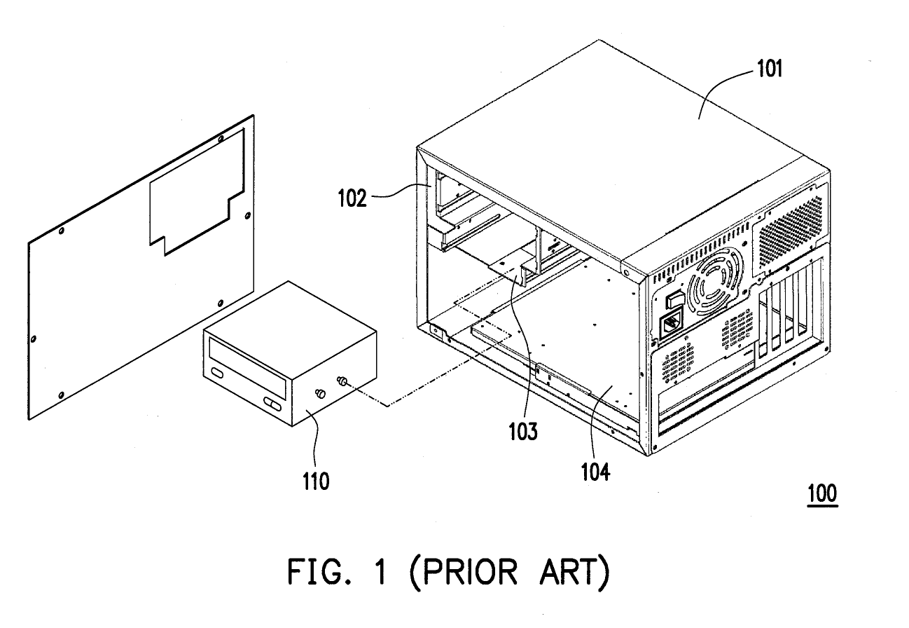

FIG. 2 is a schematic view of the combination shown in FIG. 1 as seen from another viewing angle.

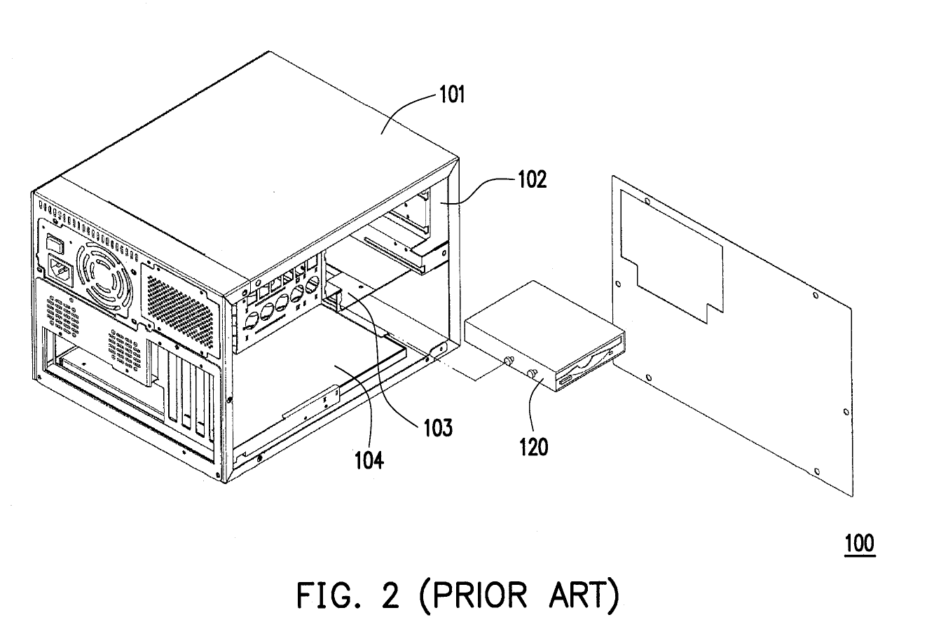

FIG. 3 is a schematic view of another conventional computer host combined with disc drives.

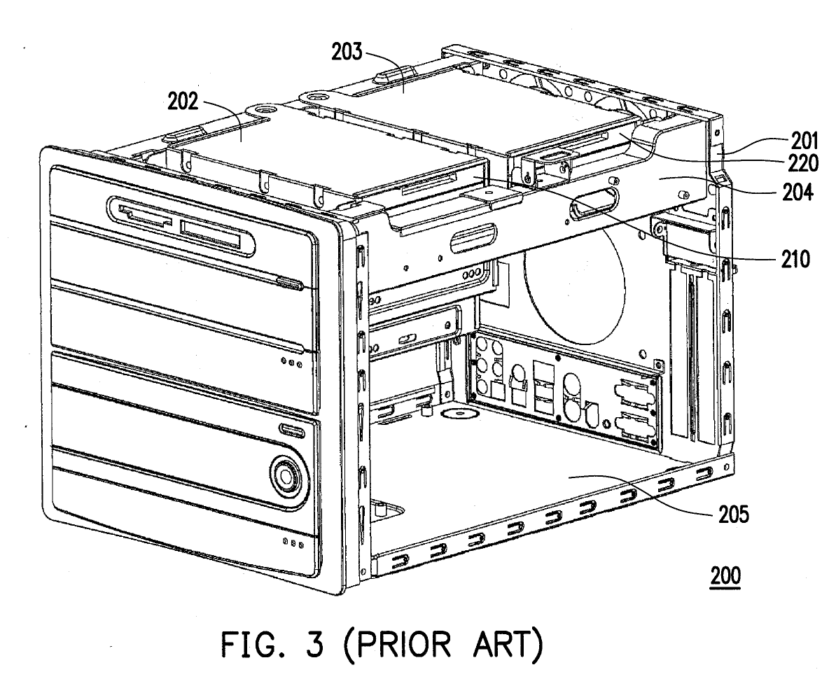

FIG. 4 is a schematic perspective view of a computer host according to an embodiment of the present invention.

FIG. 5 is an exploded perspective view of the computer host in FIG. 4.

FIG. 6 is a perspective view of disc drives assembled to a cage in FIG. 5.

### DESCRIPTION OF THE EMBODIMENTS

Reference will now be made in detail to the present embodiment of the invention, examples of which are illustrated in the accompanying drawings. Wherever possible, the same reference numbers are used in the drawings and the description to refer to the same or like parts.

In order to avoid a poor heat dissipation problem of the conventional computer host due to an excessively small distance between disc drives and the mother board caused by staking the disc drives within the case, the present invention adopts a horizontal spreading design of a cage for fixing disc drives within the case. The carried disc drives are hung at one side of the case to make full use of the inner space of the computer host, so that a heat sink on the mother board maintains an original heat dissipation performance, and thus the computer host achieves a desirable heat dissipation performance. The disc drives spreading horizontally may be optical disc drives or hard disc drives.

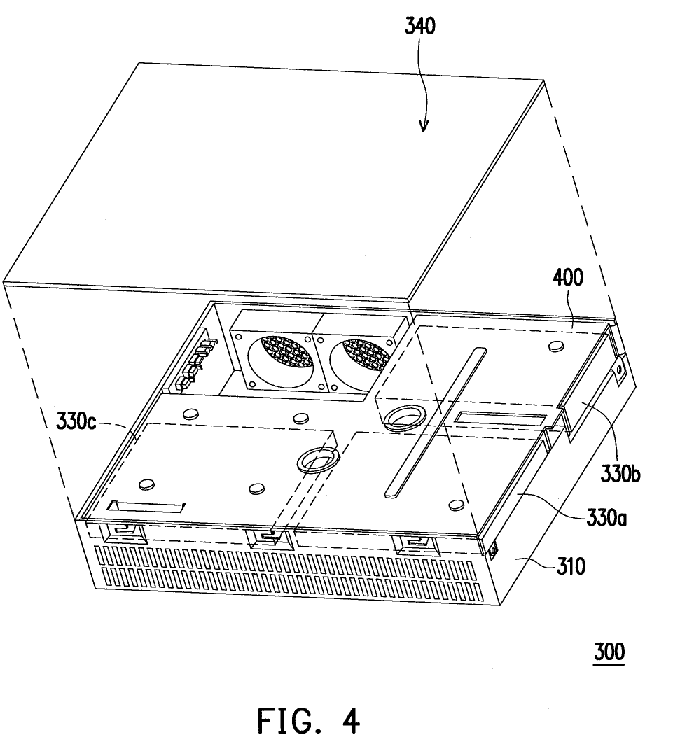

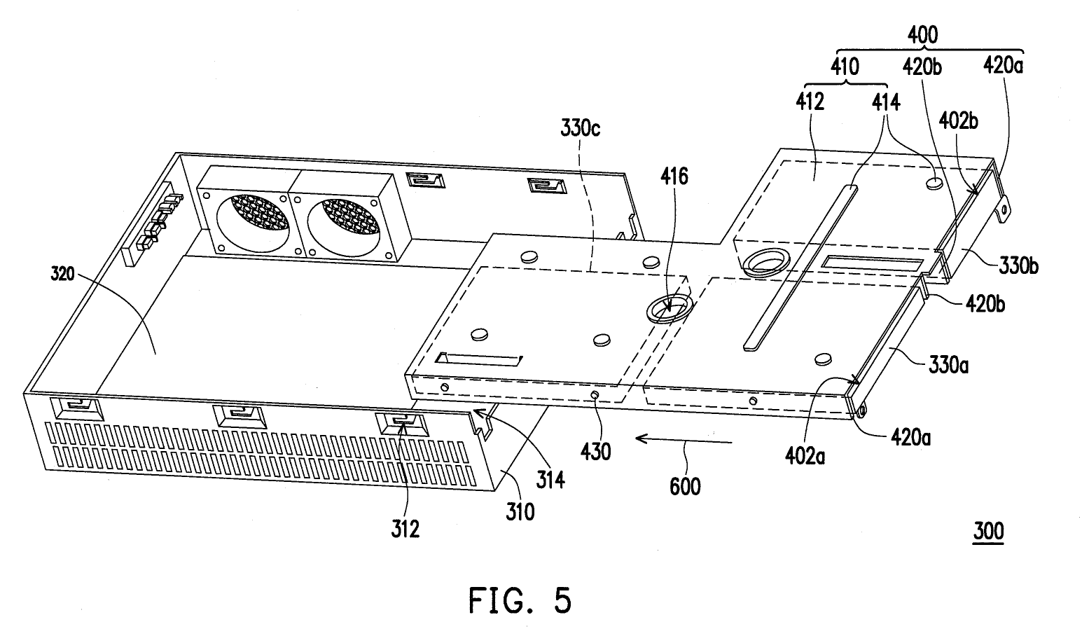

FIG. 4 is a schematic perspective view of a computer host according to an embodiment of the present invention. FIG. 5 is an exploded perspective view of the computer host in FIG. 4. Referring to FIGS. 4 and 5, a computer host 300 includes a case 310, a mother board 320, a casing cover 340, a plurality of disc drives 330a, 330b, and 330c, and a cage 400 for carrying the disc drives 330a, 330b, and 330c. The mother board 320, the disc drives 330a, 330b, and 330c, and the cages 400 are all disposed within the case 310 and the casing cover 340 covers the case 310. In this embodiment, the case 310 may be a Micro-ATX case.

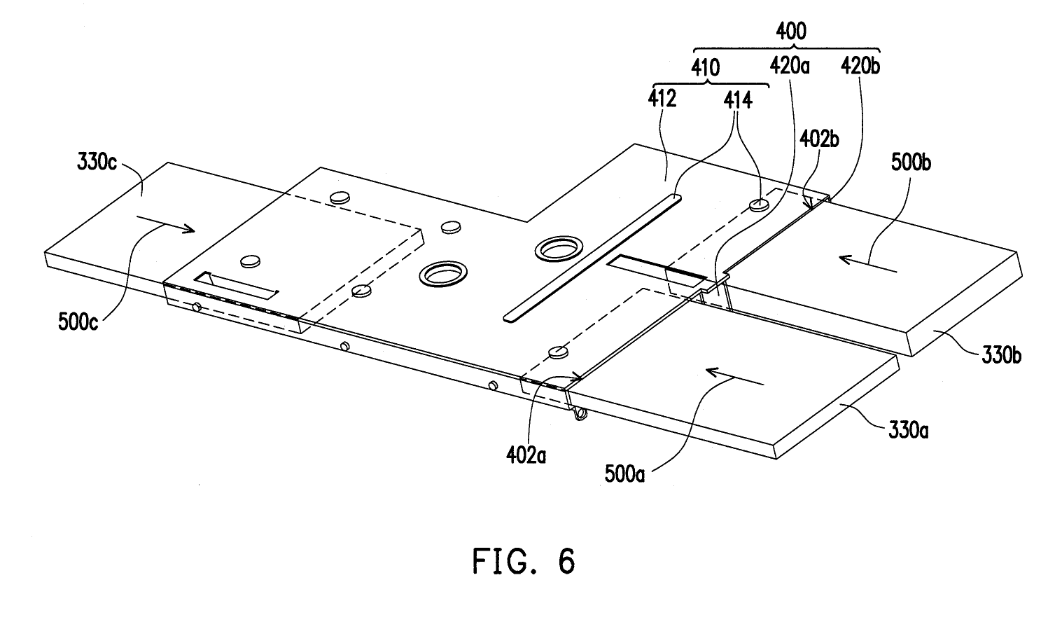

FIG. 6 is a perspective view of disc drives assembled to a cage in FIG. 5. Referring to FIGS. 5 and 6, the cage 400 includes a frame 410 and pairs of plate parts 420a and 420b. A top plate 412 of the frame 410 is substantially in parallel with the mother board 320, and a plurality of protruding structures 414 of the frame 410 protrudes towards an upper side of the top plate 412, thereby enhancing a structural strength of the top plate 412. In this embodiment, the protruding structures 414 are, for example, circular protruding structures, strip-shaped protruding structures, or protruding structures with another configuration.

The plate parts 420a and 420b are connected to the frame 410 and extend towards to one side (e.g., a lower side) of the frame 410, so as to define a plurality of disc drive assembly slots 402a and 402b at the lower side of the frame 410. The disc drive 330a is fixed within the disc drive assembly slot 402a, the disc drive 330b is fixed within the disc drive assembly slot 402b, and the disc drive 330c is fixed in the disc drive assembly slot (not shown). In other words, the disc drives 330a, 330b, and 330c are disposed in a horizontal spreading manner at the lower side of the frame 410.

In this embodiment, the plate parts 420a located at the outermost may be integrated with the frame 410, and the plate parts 420b located between the plate parts 420a are assembled on the frame 410. Furthermore, the disc drives 330a and 330c are, for example, optical disc drives, and accordingly, a size of the plate parts 420a and 420b corresponding to the disc drives 330a and 330c is substantially equal to a thickness of one optical disc drive. Moreover, the disc drive 330b is, for example, a hard disc drive, and accordingly, a size of the plate parts 420a and 420b corresponding to the disc drive 330b is substantially equal to a thickness of one hard disc drive.

As shown in FIG. 6, a user may push the disc drives 330a, 330b, and 330c along assembly directions 500a, 500b, and 500c respectively, so as to assemble the disc drives 330a, 330b, and 330c in the corresponding disc drive assembly slots 402a and 402b. Then, as shown in FIG. 5, the user pushes the cage 400 for carrying the disc drives 330a, 330b, and 330c along an assembly direction 600, so as to assembly the cage 400 in the case 310. In this way, the disc drives 330a, 330b, and 330c are hung in a horizontal spreading manner within the case 310.

Then, referring to FIGS. 4 and 6, after the disc drives 330a, 330b, and 330c are hung in a horizontal spreading manner within the case 310, the case 310 is covered by the casing cover 340. In this manner, through configuring the casing cover 340, the cage 400 is confined between the casing cover 340 and the case 310, so that the cage 400 is restricted in terms of the freedom of the mounting direction thereof, thus cannot make any displacement at all.

It should be noted that, in the prior art, a plurality of disc drives is stacked together, whereas the disc drives 330a, 330b, and 330c are hung within the cage 400 in a horizontal spreading manner in this embodiment. Therefore, an overall thickness of the cage 400 for carrying the disc drives 330a, 330b, and 330c is generally a thickness of the frame 410 plus a thickness of the thickest disc drive 330b. Thus, compared with the prior art, the overall thickness of the cage 400 in this embodiment is much smaller.

In other words, through the horizontal spreading design of the cage 400 in this embodiment, the overall thickness of the cage 400 for carrying the disc drives 330a, 330b, and 330c is reduced. Thus, even if the cage 400 is assembled within the case 310 with a smaller size, a proper gap can still be maintained between the cage 400 and the mother board 320. In this way, a heat sink (not shown) disposed on the mother board 320 can maintain the original heat dissipation performance, so that the computer host 300 achieves a desirable heat dissipation performance.

Besides, as shown in FIG. 5, the frame 410 of this embodiment further includes a plurality of assembly holes 416 formed in the top plate 412. Furthermore, the cage 400 further includes a plurality of stand-offs for assembly 430 disposed on the outermost plate parts 420a and the stand-offs for assembly 430 extend outwards. During an assembling process, an operator may hold the cage 400 by fingers or a hand tool through the assembly holes 416, and push the cage 400 into the case 310 along the assembly direction 600. Then, through the stand-offs for assembly 430 and a plurality of assembly holes 312 of the case 310, the cage 400 is assembled in the case 310. In view of the above, the assembly holes 416 may also be designed into a mechanical arm, or other forms or sizes that can be held by fingers or tools.

Particularly, the cage 400 is hung at the top of an inner space of the case 310 through the stand-offs for assembly 430 and the plurality of assembly holes 312 of the case 310. Alternatively, the cage 400 may also be hung within the case 310 through the stand-offs for assembly 430 and the assembly holes 312. Therefore, a proper gap can be maintained between the cage 400 and the mother board 320, so as to achieve a desirable heat dissipation effect.

In this embodiment, the case 310 further has a plurality of openings 314. A position and a size of each opening 314 correspond to that of the disc drives 330a, 330b, and 330c, so that the operation panels of the disc drives 330a, 330b, and 330c can be exposed out of the case 310.

To sum up, in the present invention, a plurality of disc drives is hung in a horizontal spreading manner within the case. Thus, the inner space of the computer host is utilized efficiently, so that a proper distance is maintained between the disc drives and the mother board and the heat sink disposed on the mother board further maintains a proper height, and thus the computer host achieves desirable heat dissipation efficiency.

Furthermore, when the disc drive is an optical disc drive, the operation panel of the optical disc drive is exposed out of the case through the openings of the case, so that the user can directly operate the operation panel of the optical disc drive via the opening, so that the computer host of the present invention is more convenient in use. Furthermore, through configuring the assembly holes, it further facilitates the operator to assemble the cage into the case.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cage, adapted to carry a plurality of disc drives and fix the disc drives within a case of a computer host, wherein the computer host comprises a mother board, and the disc drives are spread horizontally within the cage, so that the disc drives are hung above the mother board.

2. The cage according to claim 1, comprising a frame and pairs of plate parts, wherein the pairs of plate parts are connected to the frame and extend towards one side of the frame, so as to define a plurality of disc drive assembly slots at one side of the frame, and each of the disc drives is fixed in one disc drive assembly slot defined by one pair of plate parts, so that the disc drives are spread horizontally on the frame.

3. The cage according to claim 2, wherein the frame has at least one protruding structure protruding towards the other side of the frame.

4. The cage according to claim 3, wherein the protruding structure comprises a circular protruding structure or a strip-shaped protruding structure.

5. The cage according to claim 2, wherein the frame has at least one assembly hole.

6. The cage according to claim 2, wherein a part of the plate parts is integrated with the frame, and the remaining plate parts are assembled on the frame.

7. The cage according to claim 2, wherein a size of one part of the plate parts corresponds to a thickness of a hard disc drive and a size of another part of the plate parts corresponds to a thickness of an optical disc drive.

8. The cage according to claim 2, further comprising a plurality of stand-offs for assembly disposed on a part of the plate parts, wherein the stand-offs extend outwards.

9. A computer host, comprising:
a case;
a mother board disposed within the case;
a plurality of disc drives disposed within the case; and
a cage disposed within the case, for carrying the disc drives, wherein the disc drives are spread horizontally within the cage, so that the disc drives are hung above the mother board.

10. The computer host according to claim 9, wherein the cage comprises a frame and pairs of plate parts, the pairs of plate parts are connected to the frame and extend towards one side of the frame, so as to define a plurality of disc drive assembly slots at one side of the frame, and each of the disc drives is fixed in one disc drive assembly slot defined by one pair of plate parts respectively, so that the disc drives are spread horizontally on the frame.

11. The computer host according to claim 9, wherein the case comprises a Micro-ATX case.

12. The computer host according to claim 10, wherein the frame is substantially in parallel with the mother board.

13. The computer host according to claim 9, wherein the case has a plurality of openings, so that operation panels of the disc drives carried by the cage are exposed out of the case.

14. The computer host according to claim 10, wherein the frame has at least one protruding structure protruding towards the other side of the frame.

15. The computer host according to claim 14, wherein the protruding structure comprises a circular protruding structure or a strip-shaped protruding structure.

16. The computer host according to claim 10, wherein the frame has at least one assembly hole.

17. The computer host according to claim 10, wherein a part of the plate parts is integrated with the frame of the cage, and the remaining plate parts are assembled on the frame.

18. The computer host according to claim 10, wherein a size of a part of the plate parts corresponds to a thickness of a hard disc drive and a size of another part of the plate parts corresponds to a thickness of an optical disc drive.

19. The computer host according to claim 9, further comprising a plurality of stand-offs for assembly disposed on the cage and a plurality of assembly holes located on the case, wherein through the stand-offs for assembly and the assembly holes, the cage is hung within the case.

20. The computer host according to claim 9, further comprising a casing cover for covering the case, so as to restrict the cage from shifting.
